(19) United States
(12) Patent Application Publication
(10) Pub. No.: US 2026/0011128 A1
(43) Pub. Date: Jan. 8, 2026

(54) Document Classification and Extraction

(71) Applicant: ServiceNow, Inc., Santa Clara, CA (US)

(72) Inventors: Adam Ghadiri, Montreal (CA); Nikhil Ragipani, Hyderabad (IN); Srikanth Mallikarjuna, Santa Clara, CA (US); Nikola Simic, Santa Clara, CA (US); Amelio Rosindo Lautieri, Santa Clara, CA (US); Simon Fauvel, Montreal (CA); François Savard, Montreal (CA); Vijaya Kukapalli, Hyderabad (IN); Phani Nivarthi, Santa Clara, CA (US); Karine Grande, Paris (FR); Prithvi Mohanty, Hyderabad (IN); Mark Griffin, Santa Clara, CA (US)

(21) Appl. No.: 18/766,248

(22) Filed: Jul. 8, 2024

(51) Int. Cl. G06V 10/778; G06V 30/412; G06V 30/413

(52) U.S. Cl. CPC G06V 10/7788; G06V 30/412; G06V 30/413; G06V 2201/10

(57) ABSTRACT

Embodiments herein extract information from documents (e.g., scanned images of documents) to fields of a database or other collection of fields. The location and contents of blocks of text within the document are detected and then applied to a trained model to map a subset of the text to a set of target fields, where the target fields include one or more sets of repeated fields (e.g., corresponding to rows of a table). This mapping is presented to a user, optionally superimposed on an image of the document, to facilitate the user providing corrective feedback to the mapping. The mapping can then be updated, and the model trained to exhibit improved accuracy, based on the corrective feedback. The corrective feedback can include indicating the extent of a table and/or rows or columns thereof, facilitating correction of large numbers of field mappings.

### BACKGROUND

Identifying and extracting relevant non-textual or combined textual and non-textual information in a document is often inaccurate and computationally expensive. While optical character recognition (OCR) or other techniques can identify textual information within image content, previously available techniques lack the ability to accurately recognize a portion of a document including both textual content and non-textual content.

### SUMMARY

Documents may vary greatly over time or across sources of such documents, making it difficult or impossible to design an algorithm to extract desired information for all types of documents. Alternatively, machine learning models could be trained to extract such information. However, generating or otherwise obtaining training datasets of documents and the target information extracted therefrom to train such models is difficult and costly. Further, such trained models may exhibit poor accuracy, especially when the documents include tables, images, or other non-textual, graphically structured repeating fields of information.

The embodiments described herein allow information contained in tables or other repeated rows of a document to be quickly and accurately extracted therefrom in an automated fashion. This includes applying OCR or other techniques to identify the textual content and locations within a document of blocks of text. This information can then be passed into a trained machine learning model to predict which of the blocks of text should be mapped to which fields of a plurality of fields of information to extract from the document. By translating the image of the document into a record of the locations and content of blocks of text therein, the machine learning model used can be smaller and more accurate than, e.g., an alternative model capable of receiving a complete image of the document.

The prediction using such a smaller model can be performed locally, by one or more processors of a laptop, personal computer, or other computing device. This is because such an efficient predictive method can be implemented in a relatively computationally lightweight manner. This can reduce the bandwidth, compute, memory, or other technical costs associated with performing such re-prediction non-locally, e.g., by the same server or other remote computational system used to initially map the blocks of text of a document to fields of information to extract therefrom.

Accordingly, a first example embodiment may involve a method that includes: (i) obtaining a plurality of text blocks and metadata associated with the plurality of text blocks, wherein the metadata indicates a respective position of each of the plurality of text blocks within a document; (ii) determining, via a machine learning model based on the metadata, a mapping between a plurality of fields and a subset of the plurality of text blocks, wherein the plurality of fields includes at least one repeated set of fields; (iii) generating a graphical user interface indicating the mapping; (iv) receiving an input directed to at least one field, of the plurality of fields, of the graphical user interface; and (v) updating the mapping based on the at least one field.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a document that contains text, in accordance with example embodiments.

FIG. 6B depicts a document that contains text and the locations of detected blocks of text within the document, in accordance with example embodiments.

FIG. 6C depicts a document that contains text and a mapping of portions of that text to fields of a form, in accordance with example embodiments.

FIG. 6D depicts a document that contains text and a user indication of the extent of a table within the document, in accordance with example embodiments.

FIG. 6E depicts a document that contains text and elements of a user interface for adjusting the detected extent of rows and columns of a table within the document, in accordance with example embodiments.

FIG. 6F depicts a document that contains text and elements of a user interface for adjusting the mapping of text in the documents to fields of a form, in accordance with example embodiments.

FIG. 6G depicts a document that contains text and elements of a user interface for adjusting the mapping of text in the documents to fields of a form, in accordance with example embodiments.

FIG. 6H depicts a document that contains text and elements of a user interface for adjusting the mapping of text in the documents to fields of a form, in accordance with example embodiments.

FIG. 7 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is efficiently and accurately ingesting data from documents. In practice, this is problematic because certain documents can include many pieces of information to be ingested but organized in a manner that varies significantly. This makes it very hard to code a program to extract such data (e.g., due dates, contact information, sets of objects, associated quantities, and other data). Machine learning models can be trained to perform such a task, however, it can be difficult to acquire sufficient training data to train such a model.

In other techniques, such a trained machine learning model could receive an image of an input document and generate therefrom outputs representing the target information therein. However, models capable of receiving whole images as input (e.g., convolutional neural networks) are often very computationally expensive to execute. Additionally, such models can require a prohibitive amount of training data in order to achieve reasonable accuracy.

The embodiments herein overcome these limitations by using optical character recognition (OCR) to translate a document (e.g., an image of a document) into a set of text blocks and associated metadata that indicates the locations of the text blocks within the document. The text blocks and associated location metadata are then applied as inputs to a machine learning model that determines therefrom a mapping between a plurality of target fields and the text blocks. This allows the content (e.g., numbers, names, etc.) of the mapped text blocks to be used to populate the values of the corresponding fields, e.g., in a database entry for the document. The plurality of target fields can include one or more repeated sets of fields, e.g., corresponding to rows (or columns) of a table in the document. In this manner, the model can be significantly smaller or otherwise computationally less expensive to execute (relative, e.g., to a model that receives the document as an image) while still being able to operate on spatial data about the arrangement of the text within the document (represented in the metadata). Such a smaller model can also be trained to a desired level of accuracy using fewer training data examples.

The accuracy of such a model could be improved by obtaining additional training data and using the addition training data to fine-tune or otherwise update the model. However, such data is difficult to obtain. The embodiments described herein address this technical issue by providing improved methods for human users to adjust the model-generated mappings, allowing those adjustments to be used as training data to further train the model. In previous attempts at receiving human corrections to such ingested data, human users would manually adjust the ingested data values one by one, e.g., in a textual or otherwise non-visual interface.

The present embodiments improve on prior efforts by indicating the mapping in a graphical user interface (GUI) (e.g., overlaid on an image of the source document), allowing the human user to easily indicate, in a minimum of clicks or other interactions, which text blocks have been incorrectly mapped to target fields and to indicate the correct mapping of such fields. The embodiments described herein can provide additional improvements in obtaining user feedback on the model-generated mapping by allowing the user to indicate the extent of tables within the document (e.g., to indicate the outline of a table, to indicate the location and/or extent of one or more rows and/or columns of a table). The indicated table extent information can then be used (e.g., by a heuristic algorithm) to re-map repeated sets of fields to blocks of text located within the indicated extent of the table. This provides a significant improvement to the operation of the GUI itself, since a single user interaction (e.g., the indication of the boundaries of a table in the document) can result in the re-mapping of many of the target fields (e.g., many repeating sets of fields, each repeating set corresponding to a row or column of the table) to blocks of text of the document. The embodiments herein also facilitate a user easily, and with a reduced number of interactions, providing feedback to adjust the detected number and extent of the rows/columns of tables in the document.

These embodiments also provide reductions in the computational cost (e.g., in bandwidth, in processor cycles to serve pages or other interactions) of obtaining user feedback by reducing the amount of user interactions needed to obtain such feedback (e.g., relative to a using correcting the model-generated mapping of individual fields).

Re-mapping blocks of text to target fields (e.g., to repeated sets of fields of, e.g., rows of a table) can be performed using relatively simple methods (e.g., predicting the edges of columns and/or rows as clusters of edges of locations, edges of bounding boxes containing the blocks of text within the indicated extent of a table, and/or as related to identified regions of contiguous whitespace), significantly reducing the computational cost of such re-mapping relative to, e.g., subjecting text blocks within the indicated extent of the table to re-inference by the machine learning model. Indeed, such a re-mapping method could be sufficiently computationally inexpensive that it could be performed locally, by an application or script or app executed by a browser running on a local computer (e.g., a laptop, a tablet) being used by a user to provide feedback on a model-generated mapping of text blocks to target fields. Performing such re-mapping in such a local manner could provide a variety of benefits, e.g., reducing the bandwidth cost of transmitting user feedback to a remote system and receiving the re-mapping generated by a remote system, as well as avoiding the latency cost of such communication.

Once a machine learning model has been trained on such user feedback, it can provide accurate predictions not only of the mappings between target fields and blocks of text within a document, but also accurate predictions of the level of confidence in each such mapping. Such confidence outputs can be used to provide further benefits. For example, if the model-output confidence in all of the mappings for a given document exceed a threshold confidence value, then the mapping for that document could be finalized without user verification, avoiding the bandwidth, processor cycles, latency, and other computational costs of obtaining user feedback for the mapping. Additionally or alternatively, if one or more of the mappings for a given document do not exceed the threshold confidence value, then only such low-confidence mapping could be indicated to the user for verification and possible re-mapping, reducing the computational costs of obtaining user feedback for the mapping by limiting such feedback only to the low-confidence mappings.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

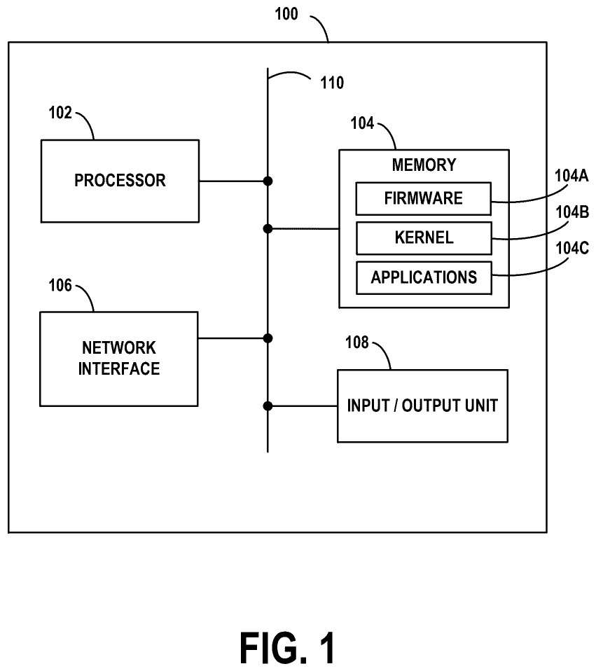

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

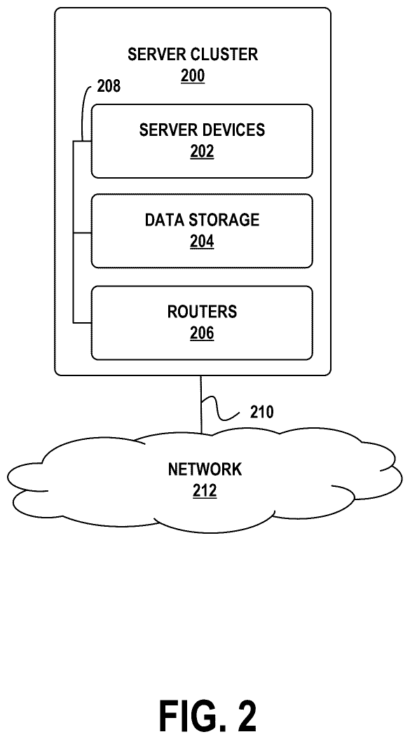

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

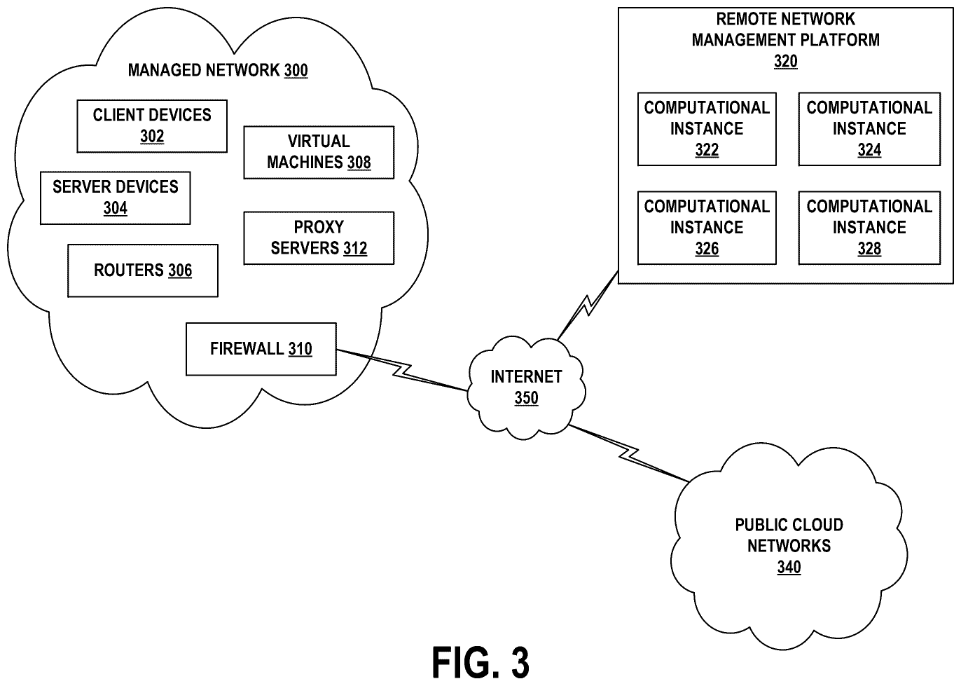

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

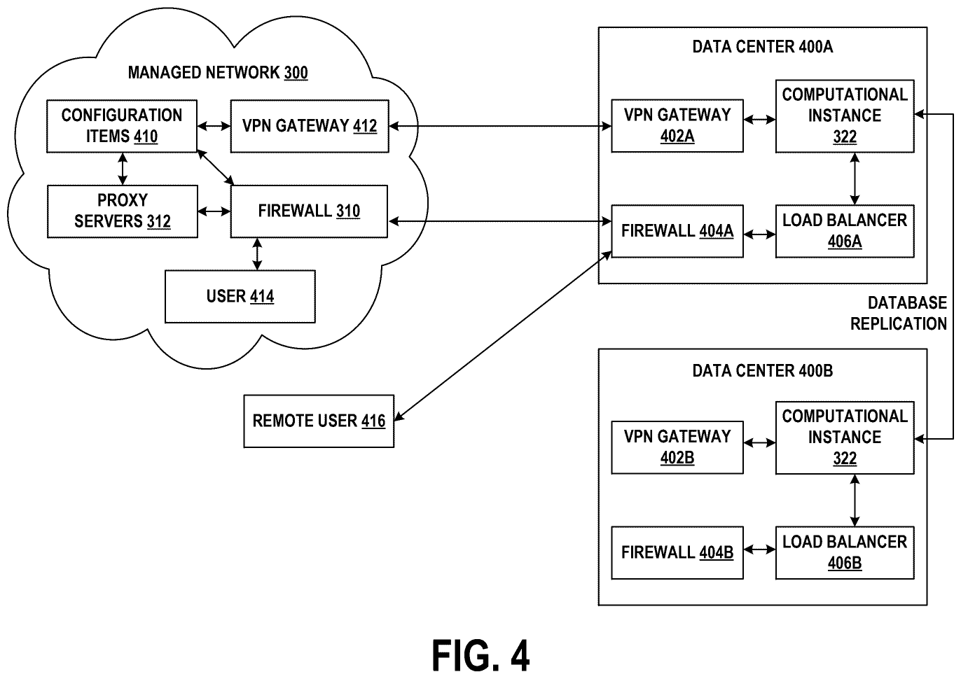

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

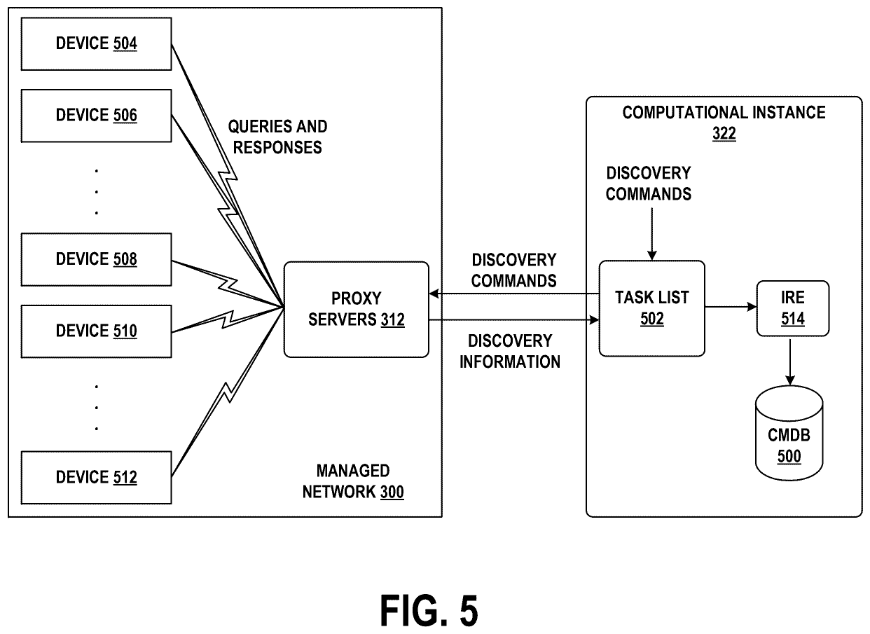

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Data Extraction From Documents

It is desirable in a variety of applications to extract information of interest from documents (e.g., from images that represent documents), e.g., to populate fields of database entries that respectively represent the relevant informational contents of such documents. For example, it could be desirable to extract performance values or other metrics from a report on the environmental, computational, or other aspects of the performance of a cloud computing environment, server, or other computational system (e.g., in order to update the configuration of such a system to improve its performance, reduce its energy consumption, or reduce its environmental impact). In another example, it could be desirable to extract a payment due date, payment method, contact information, total invoiced amount, the identity, quantity, unit price, or other information about invoiced goods or services from an invoice in order to, e.g., automate the payment of the invoice, audit payments, or provide some other benefit.

Extracting relevant information from such documents (e.g., to populate the fields of a database entry, form, or other structured record) can be performed by human operators; however, this takes much more time and is prone to errors. Heuristic algorithms or other hard-coded applications can be developed to perform the task more quickly and with more accurate transcription of values; however, the large degree of variability within a target population of documents (e.g., engineering reports, invoices) means that such applications are likely to fail to successfully extract all fields for many target documents, especially those that contain tables or other spatially structured arrangements of data. Alternatively, machine learning models can be trained to accept images of the documents and generate therefrom the values for a set of target fields; however, such models (e.g., convolutional neural networks (CNNs)) are computationally expensive to train and execute and require very large amounts of training data to achieve accuracy. While automated methods (e.g., heuristic algorithms, trained machine learning models) could be used to generate an initial proposed extraction from a document, with a human user then reviewing and correcting the proposed extraction, previous methods for presenting users with such outputs and receiving user's corrections thereto required significant numbers of user interactions, resulting in significant time and computational costs.

The embodiments herein provide various improvements to the technological process of extracting information from documents. A target document is first subjected to optical character recognition (OCR) or some other text location and identification process to obtain a plurality of text blocks in the document and metadata that indicates the respective positions of the text blocks within the document. This extracted information (the text blocks and metadata) is then applied as input to a machine learning model to determine a mapping between a plurality of target fields and a subset of the plurality of text blocks, allowing the content of the mapped text blocks (e.g., names, numbers) to be extracted to the mapped fields of a database entry or other structured data storage object. Since the model inputs are blocks of text and position-indicating metadata, the machine learning model can be much smaller (e.g., with respect to number of parameters) and computationally cheaper to execute (e.g., with respect to processor cycles, time to execute, memory needed to execute the model, storage needed to maintain the model, bandwidth needed to access the stored model) than an alternative model configured to receive the document directly as an image (e.g., a model that includes a CNN). A model as described herein can also be trained to a desired level of accuracy using less training data than such an alternative image-input model.

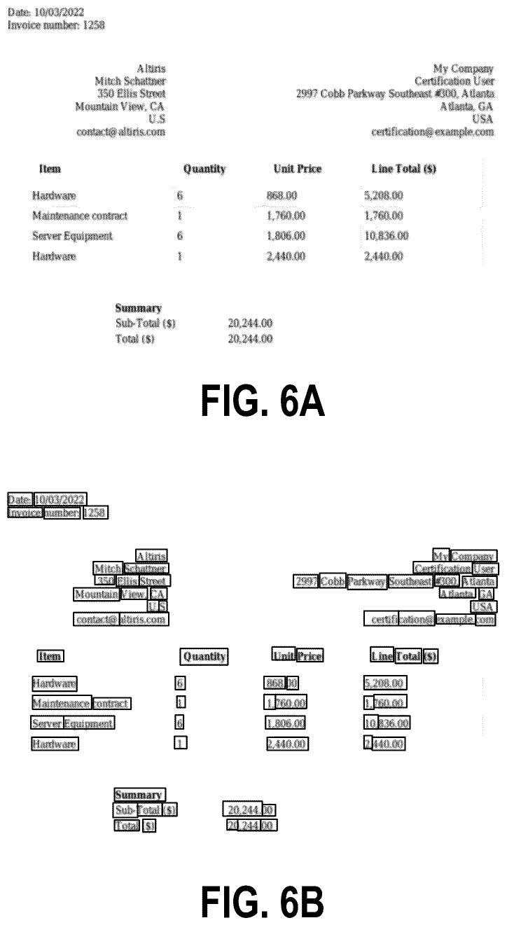

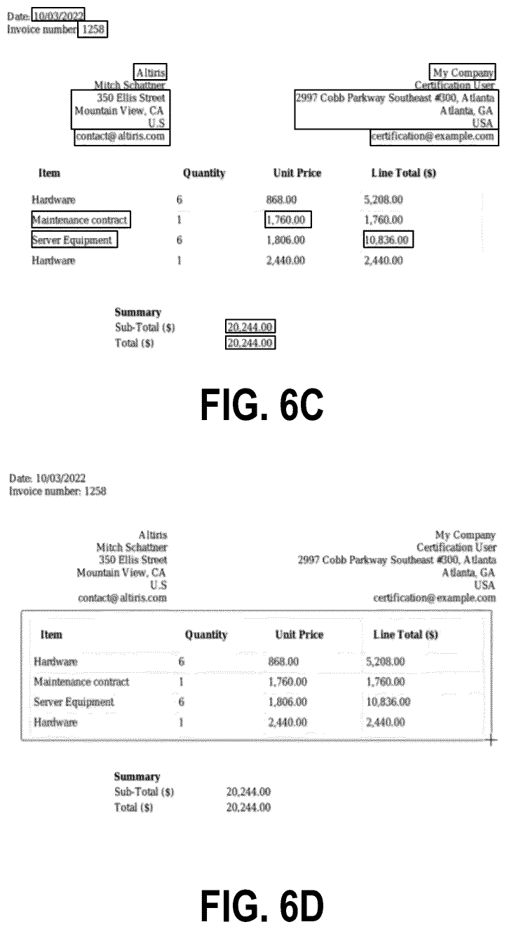

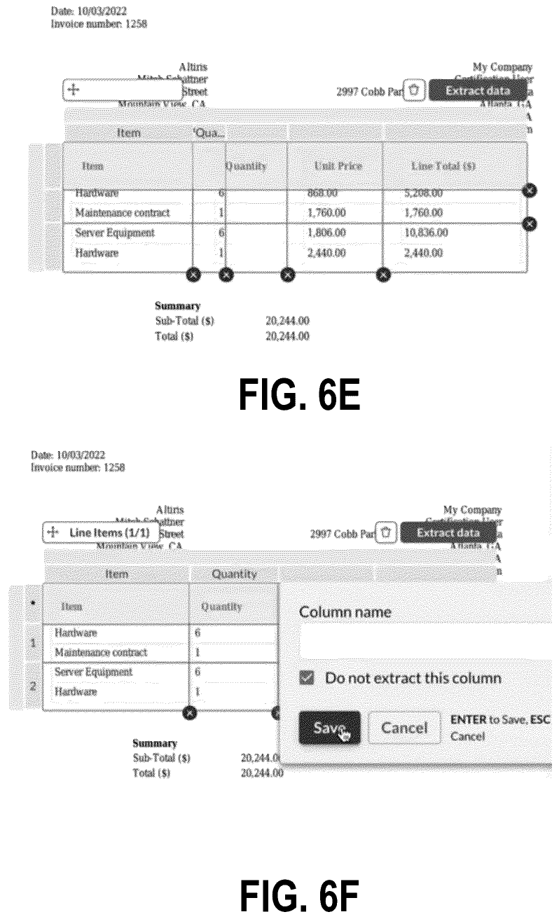

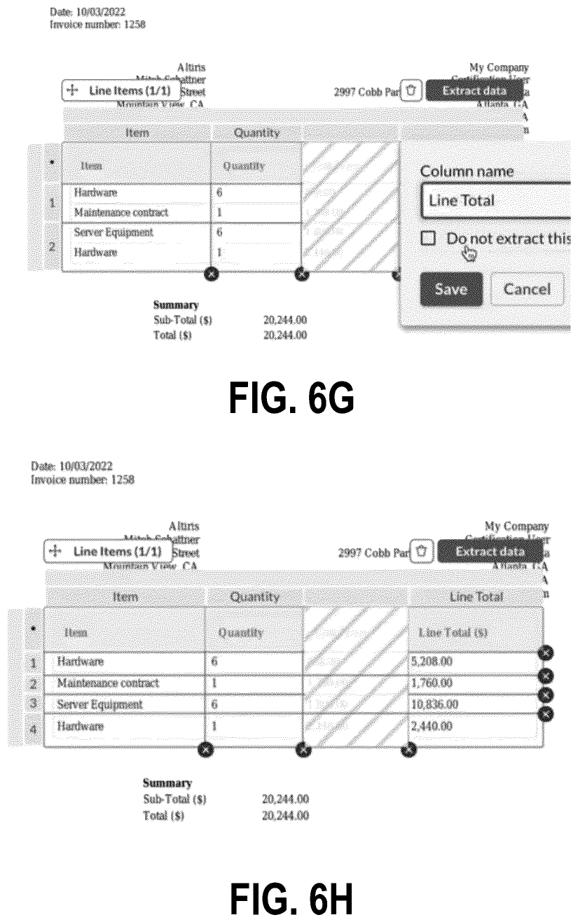

FIG. 6A depicts an example of a document that could be subjected to the methods described herein. The document may be represented as an image (e.g., as a scan of a physical document, as an image contained in a portable document file (PDF) or other document image format) or other image-like data object. FIG. 6B depicts the results of OCR or some other text identification and location process whereby the location of blocks of text (indicated by the block boxes in FIG. 6B) have been determined, as have the textual contents of those text blocks (e.g., the upper-left-most text block is “Date: ”, while the text block to the immediate right of that text block is “Oct. 3, 2022”). Metadata representing the position of the text blocks within the document could be formatted in a variety of ways, e.g., a single pair of numbers representing the X and Y position of the center, upper left corner, or some other representative location of the text block, a quartet of numbers representing the X and Y position of the text block and the height and width of the text block, a quartet of numbers representing the X and Y position of one corner and the X and Y position of the opposite corner, or some other representation of the location, size, or other information about the position of a text block within a document.

A GUI can then be provided to indicate the mapping to the user (e.g., with the mappings indicated overlaid over an image or other indication of the document), allowing the user to provide inputs directed to at least one of the mapped fields in order to correct one or more errors in the mapping. This can include, e.g., the user clicking on or otherwise interacting with an indication of one (or more) of the mappings and then providing an input to correct the mapping, e.g., by clicking or otherwise selecting one or more blocks of text that should, instead, be mapped to the field corresponding to the user-indicated mapping. This provides an improvement to the operation of the GUI and to the operation of the underlying computer systems relative to previous methods of correcting such an erroneous data extraction, wherein the user would manually correct the value of a mis-mapped field, leading to reduced accuracy and increased time and computational costs (due, e.g., to increased bandwidth, latency, database calls, or other costs related to the user accessing the database entry or other data storage object to which values from a target document have been extracted according to an erroneous mapping).

FIG. 6C depicts a GUI that indicates mappings of fields (indicated in FIG. 6C as black boxes) to text blocks of the document. So, for example, one of the top-most text blocks has been mapped to an “Invoice date” field. As shown, the model has failed to accurately map text blocks to repeated “Item Identity” and “Item Total” fields corresponding to a table in the document; as shown, the two “Hardware” items were not mapped to corresponding “Item Identity” fields at all, and the “Item Total” field for the “Maintenance Equipment” item was mis-mapped to the “Unit Price” text block(s). Note the mapping of fields can include mapping multiple text blocks to a single field, e.g., where an OCR process has broken up a set of text that represents a single field into multiple text blocks.

In some examples, the user input can be directed to multiple fields, leading to re-mapping of multiple (e.g., dozens, hundreds) of fields via few (or one) user input. For example, the user input could indicate an extent of a table within the document (e.g., could indicate the boundaries of the table, could indicate the boundaries of one or more rows or columns of the table) and then the remapping of fields of the table (e.g., of repeated sets of fields corresponding to rows or columns of the table) to text blocks located wholly or partially within the indicated extent. FIG. 6D depicts an example of a user indicating the extent of a table (in the depicted example, by indicating the outer boundaries of the table) within a document. This improvement to the GUI allows a small amount of user input (e.g., indicating the boundaries of a table) to be used to direct the re-mapping of many fields to text blocks in the document, significantly reducing the amount of user interaction needed to result in such re-mapping (e.g., compared to individually re-mapping each incorrectly mapped field). This can be applied in common to portions of a single table that are located on, e.g., different pages of the document. This reduction in the amount of user input can also reduce the time and computational cost of obtaining such update information (e.g., by reducing the time, processor cycles, bandwidth, or other computational resources associated with servicing multiple user interactions vs. a single interaction).

The user indication of the extent of the table can then be used, in combination with the metadata representing the positions of text blocks fully or partially within the indicated extent, to re-map those text blocks. FIG. 6E depicts a GUI providing an indication of the result of such a re-mapping, which includes predicting the number and extent of rows and columns of the indicated table. This GUI can then be manipulated by a user in order to either approve the prediction (e.g., by clicking the “Extract data” button), leading to extraction of data from the text blocks of the document according to the re-mapping or to correct or otherwise modify the prediction. For example, the user could adjust the predicted number and boundaries of the rows and columns (e.g., by clicking and dragging the black “X” buttons depicted in FIG. 6E). By providing an indication of the predicted rows/columns of the table overlaid on the image of the document, the user can align the row/column boundaries with visual indications thereof on the document itself.

Such a GUI can also include other functionality to receive, via a small number of user interactions, other information about the table, its contents, or about the mapping thereof to a set of target fields. For example, the GUI could allow a user to indicate that the contents of a particular column (or row) should not be mapped to any fields (e.g., as depicted in FIG. 6F). In another example, the GUI could allow a user to indicate which field, of a repeated set of fields, to map the contents of a particular column (or row) to (e.g., as depicted in FIG. 6G). Once a user has accepted the re-mapping (optionally following user inputs to adjust the re-mapping), values can be extract from text blocks of the document by mapping text blocks positioned within each cell (wholly or partially) to respective repeated sets of target fields. For example, FIG. 6H depicts a re-mapping of the contents of a table, with one of the columns specified to not have text blocks mapped thereto, that could be used to extract values for the mapped fields (e.g., in response to the user clicking the “Extract data” button).

By leveraging a user indication of the extent of a table or other spatially structured array of text, simpler, less computationally expensive methods can be used to determine the updated mapping for text blocks positioned wholly or partially within the indicated extent. For example, the edges of columns and/or rows could be predicted by detecting clusters of edges of text block locations and/or edges of bounding boxes containing the blocks of text within the indicated extent of a table. Such methods are significantly less computationally expensive than alternative methods, e.g., relative to performing a re-inference using a machine learning model.

Indeed, such a mapping method applied within the indicated extent of a table could be sufficiently low in computational cost (e.g., with respect to memory use, processor cycles, etc.) that it could be performed by a laptop, tablet, or other computing system being used to provide the GUI to a user and to receive inputs therefrom. Such local computing systems may lack the computational resources to execute, or even to store, the machine learning model used to generate the initial mapping for a document. Additionally, by performing the re-mapping of text blocks within the table locally, communications bandwidth could be reduced between the user's local system and whatever remote server was used to execute the machine learning model, to obtain and extract blocks of text from the document, or to perform database-related tasks using data extracted from the document based on a finalized mapping. This is especially true in examples wherein the user repeatedly modifies the mapping to text blocks within the table (e.g., by adjusting the extents of rows and/or columns thereof), since inter-system bandwidth related to such serial user inputs can be avoided. Instead, bandwidth can be reserved to communicate the final re-mapping of text within the table once the user has completed their adjustments (indicating that completion by, e.g., pressing an “Extract data” button or other GUI element to indicate that completion).

Corrective user feedback on model-predicted mappings can also be used to update the machine learning model, allowing it to generate improved mappings for subsequent documents. To perform this training, the final user-approved mappings could be stored as training data and used to update the model. Additionally or alternatively, where the user input includes indications of the extent of tables and/or of rows and columns thereof, such table positional information could also be provided to update the model. This could include generating loss information to train an intermediate layer of the model to comport with the user-specified table position data and/or training the model to generate, in addition to the mappings, outputs that specify positional data for one or more tables (e.g., the extent of such table(s), the number and extent of rows and/or columns thereof). Where the model is trained to generate table positional data as an output, such output could be provided to the user via a GUI (e.g., as starting point for the user to adjust in order to correct inaccuracies in the model prediction when indicating the extent of a table and/or of rows or columns thereof).

Once the machine learning model has been sufficiently trained, it can also output confidence scores for each of its output mappings, representing how likely it is that the mappings are correct (or incorrect). Such mappings can then be used to provide additional user interface or other improvements. For example, if all of the mappings output by the model for a particular document exhibit high confidence levels (e.g., the confidence scores for all of the mappings exceed a threshold confidence value), then the data could be extracted from the document without consulting a human user to adjust or verify the predicted mappings. Such operations avoid the computational costs (e.g., time, latency, bandwidth, memory, processor cycles, database calls) associated with providing a GUI to a user and receiving thereby user input on mappings that have been determined sufficiently likely to be correct (as measured by the confidence scores). For documents whose model-generated mappings include one or more mappings with low confidence (e.g., with confidence scores that do not exceed the threshold confidence value), user feedback on the mappings could be obtained. This could include presenting an indication only of the low-confidence mappings to the user, saving time and computational costs by limiting user interactions (and the associated time, latency, bandwidth, memory, processor cycles, database calls) to the subset of the mappings that were determined less likely to be correct (as measured by the confidence scores).

### VIII. Example Operations

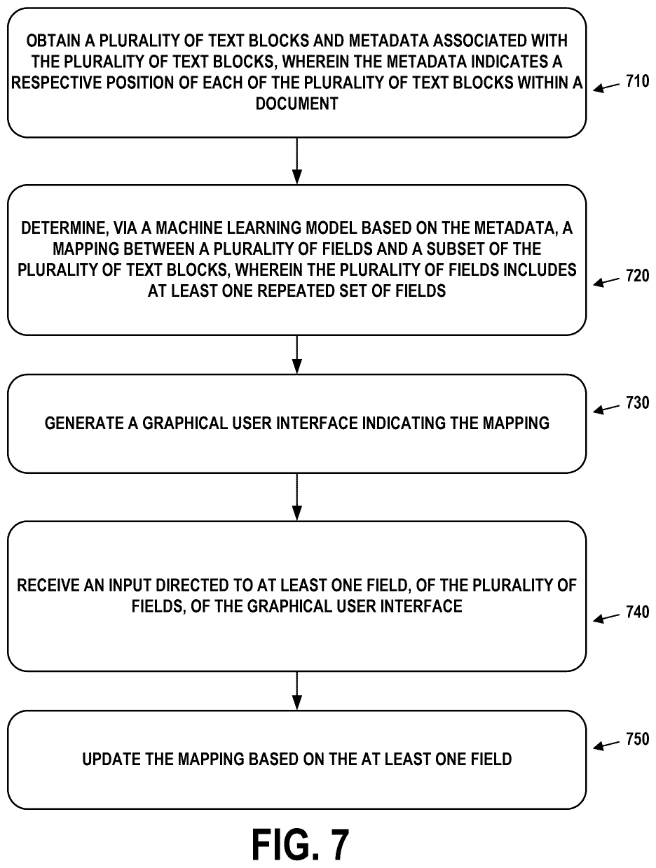

FIG. 7 is a flow chart illustrating an example embodiment. The process illustrated by FIG. 7 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 7 may be simplified by the removal of any one or more of the features shown therein. Further, these embodiments may be combined with features, aspects, and/or implementations of any of the previous figures or otherwise described herein.

The embodiments of FIG. 7 include obtaining a plurality of text blocks and metadata associated with the plurality of text blocks, wherein the metadata indicates a respective position of each of the plurality of text blocks within a document (710). This could be accomplished by, e.g., applying an OCR algorithm to an image of the document.

The embodiments of FIG. 7 further include determining, via a machine learning model based on the metadata, a mapping between a plurality of fields and a subset of the plurality of text blocks, wherein the plurality of fields includes at least one repeated set of fields (720).

The embodiments of FIG. 7 additionally include generating a graphical user interface indicating the mapping (730). This could include generating a graphical user interface indicating the mapping overlaid on an indication of the document (e.g., overlaid on an image of the document).

The embodiments of FIG. 7 yet further include receiving an input directed to at least one field, of the plurality of fields, of the graphical user interface (740).

The embodiments of FIG. 7 also include updating the mapping based on the at least one field (750). In some examples, determining the mapping could be performed by a server, generating the graphical user interface could include a computer system that is remote from and in communication with the server providing the graphical user interface, and updating the mapping could be performed by a controller of the computing system. This could reduce the amount of bandwidth used for the computing system and server to communicate with each other by performing some operations (e.g., providing the GUI and updating the mapping) locally on the computing system. These benefits may be amplified by the fact that such remapping may be performed multiple times by a user providing feedback on the mapping (e.g., in the form of indicating an extent of a table within the document or providing some other input directed to at least one field of the plurality of fields) and on the re-mapping multiple times.

In some examples, each repeated set of fields represents a respective row of a table within the document. In such examples, receiving the input directed to the at least one field includes receiving an input indicating an extent of the table within the document (e.g., the extent of the outer edges of the tables, and/or the extent of one or more rows and/or columns of the table within the document). Updating the mapping can then include, based on the extent of the table and the metadata, updating the mapping between the at least one repeated set of fields and at least one text block whose location within the document corresponds to the extent of the table within the document. This ‘spatial’ user feedback (i.e., about the extent of the table within the document) can allow re-mapping blocks of text to target fields to be performed using relatively simple methods (e.g., predicting the edges of columns and/or rows as clusters of edges of locations and/or edges of bounding boxes containing the blocks of text within the indicated extent of a table), significantly reducing the computational cost of such re-mapping relative to, e.g., subjecting text blocks within the indicated extent of the table to re-inference by the machine learning model. Receiving feedback from a user in this manner also provides a significant improvement to the operation of the GUI itself, since a single user interaction results in the re-mapping of many of the target fields to blocks of text of the document. This also allows a user to easily, and with a reduced number of interactions, provide feedback to adjust the detected number and extent of the rows/columns of tables in the document.

The embodiments of FIG. 7 may include additional or alternative steps or features. For example, the embodiments of FIG. 7 could additionally include, based on the updated mapping, training the machine learning model to generate an updated machine learning model. Such an updated model could then be used to extract data from additional documents, e.g., by (i) obtaining an additional plurality of text blocks and additional metadata associated with the additional plurality of text block, wherein the additional metadata indicates a respective position of each of the additional plurality of text blocks within an additional document; (ii) determining, via the updated machine learning model based on the metadata, (a) an additional mapping between the plurality of fields and a subset of the additional plurality of text blocks and (b) confidence scores for the additional mapping of each of the plurality of fields; (iii) determining that at least one of the confidence scores does not exceed a confidence threshold; and (iv) responsive to determining that at least one of the confidence scores does not exceed the confidence threshold, generating a graphical user interface indicating the additional mapping of at least one of the plurality of fields that corresponds to the at least one of the confidence scores that does not exceed the confidence threshold. Such operations could reduce the computational cost (e.g., bandwidth, processor cycles, latency, and other computational costs of obtaining user feedback for a model-generated mapping) by only indicating low-confidence mappings to a user for verification and possible re-mapping and/or by avoiding the process of obtaining user feedback altogether for documents for which the updated model only outputs high-confidence mappings.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a plurality of text blocks and metadata associated with the plurality of text blocks, wherein the metadata indicates a respective position of each of the plurality of text blocks within a document;
determining, via a machine learning model based on the metadata, a mapping between a plurality of fields and a subset of the plurality of text blocks, wherein the plurality of fields includes at least one repeated set of fields;
generating a graphical user interface indicating the mapping;
receiving an input directed to at least one field, of the plurality of fields, of the graphical user interface; and
updating the mapping based on the at least one field.

2. The method of claim 1, wherein obtaining the text blocks and metadata comprises performing optical character recognition on an image of the document.

3. The method of claim 1, further comprising:
based on the updated mapping, training the machine learning model to generate an updated machine learning model.

4. The method of claim 3, further comprising:
obtaining an additional plurality of text blocks and additional metadata associated with the additional plurality of text block, wherein the additional metadata indicates a respective position of each of the additional plurality of text blocks within an additional document;
determining, via the updated machine learning model based on the metadata, (i) an additional mapping between the plurality of fields and a subset of the additional plurality of text blocks and (ii) confidence scores for the additional mapping of each of the plurality of fields;
determining that at least one of the confidence scores does not exceed a confidence threshold; and
responsive to determining that at least one of the confidence scores does not exceed the confidence threshold, generating a graphical user interface indicating the additional mapping of at least one of the plurality of fields that corresponds to the at least one of the confidence scores that does not exceed the confidence threshold.

5. The method of claim 4, wherein generating the graphical user interface indicating the mapping comprises generating a graphical user interface indicating the mapping overlaid on an indication of the document, and wherein generating the graphical user interface indicating the additional mapping comprises generating a graphical user interface indicating the additional mapping of at least one of the plurality of fields that corresponds to the at least one of the confidence scores that does not exceed the confidence threshold overlaid on an indication of the additional document.

6. The method of claim 1, wherein determining the mapping is performed by a server, wherein generating the graphical user interface comprises providing the graphical user interface by a computing system that is remote from and in communication with the server, and wherein updating the mapping is performed by a controller of the computing system.

7. The method of claim 1, wherein each repeated set of fields represents a respective row of a table within the document, wherein receiving the input directed to the at least one field comprises receiving an input indicating an extent of the table within the document, and wherein updating the mapping comprises, based on the extent of the table and the metadata, updating the mapping between the at least one repeated set of fields and at least one text block whose location within the document corresponds to the extent of the table within the document.

8. The method of claim 1, wherein generating the graphical user interface indicating the mapping comprises generating a graphical user interface indicating the mapping overlaid on an indication of the document.

9. A non-transitory computer-readable medium, having stored thereon program instructions that, upon execution by a computing system, cause the computing system to perform operations comprising:
obtaining a plurality of text blocks and metadata associated with the plurality of text blocks, wherein the metadata indicates a respective position of each of the plurality of text blocks within a document;
determining, via a machine learning model based on the metadata, a mapping between a plurality of fields and a subset of the plurality of text blocks, wherein the plurality of fields includes at least one repeated set of fields;
generating a graphical user interface indicating the mapping;
receiving an input directed to at least one field, of the plurality of fields, of the graphical user interface; and
updating the mapping based on the at least one field.

10. The non-transitory computer-readable medium of claim 9, wherein obtaining the text blocks and metadata comprises performing optical character recognition on an image of the document.

11. The non-transitory computer-readable medium of claim 9, wherein the operations further comprise:
based on the updated mapping, training the machine learning model to generate an updated machine learning model;
obtaining an additional plurality of text blocks and additional metadata associated with the additional plurality of text block, wherein the additional metadata indicates a respective position of each of the additional plurality of text blocks within an additional document;
determining, via the updated machine learning model based on the metadata, (i) an additional mapping between the plurality of fields and a subset of the additional plurality of text blocks and (ii) confidence scores for the additional mapping of each of the plurality of fields;
determining that at least one of the confidence scores does not exceed a confidence threshold; and
responsive to determining that at least one of the confidence scores does not exceed the confidence threshold, generating a graphical user interface indicating the additional mapping of at least one of the plurality of fields that corresponds to the at least one of the confidence scores that does not exceed the confidence threshold.

12. The non-transitory computer-readable medium of claim 9, wherein determining the mapping is performed by a server, wherein generating the graphical user interface comprises providing the graphical user interface by a computing system that is remote from and in communication with the server, and wherein updating the mapping is performed by a controller of the computing system.

13. The non-transitory computer-readable medium of claim 9, wherein each repeated set of fields represents a respective row of a table within the document, wherein receiving the input directed to the at least one field comprises receiving an input indicating an extent of the table within the document, and wherein updating the mapping comprises, based on the extent of the table and the metadata, updating the mapping between the at least one repeated set of fields and at least one text block whose location within the document corresponds to the extent of the table within the document.

14. The non-transitory computer-readable medium of claim 9, wherein generating the graphical user interface indicating the mapping comprises generating a graphical user interface indicating the mapping overlaid on an indication of the document.

15. A system comprising:
one or more processors; and
memory, containing program instructions that, upon execution by the one or more processors, cause the system to perform operations comprising:
obtaining a plurality of text blocks and metadata associated with the plurality of text blocks, wherein the metadata indicates a respective position of each of the plurality of text blocks within a document;
determining, via a machine learning model based on the metadata, a mapping between a plurality of fields and a subset of the plurality of text blocks, wherein the plurality of fields includes at least one repeated set of fields;
generating a graphical user interface indicating the mapping;
receiving an input directed to at least one field, of the plurality of fields, of the graphical user interface; and
updating the mapping based on the at least one field.

16. The system of claim 15, wherein obtaining the text blocks and metadata comprises performing optical character recognition on an image of the document.

17. The system of claim 15, wherein the operations further comprise:
based on the updated mapping, training the machine learning model to generate an updated machine learning model;
obtaining an additional plurality of text blocks and additional metadata associated with the additional plurality of text block, wherein the additional metadata indicates a respective position of each of the additional plurality of text blocks within an additional document;
determining, via the updated machine learning model based on the metadata, (i) an additional mapping between the plurality of fields and a subset of the additional plurality of text blocks and (ii) confidence scores for the additional mapping of each of the plurality of fields;
determining that at least one of the confidence scores does not exceed a confidence threshold; and
responsive to determining that at least one of the confidence scores does not exceed the confidence threshold, generating a graphical user interface indicating the additional mapping of at least one of the plurality of fields that corresponds to the at least one of the confidence scores that does not exceed the confidence threshold.

18. The system of claim 15, wherein determining the mapping is performed by a server, wherein generating the graphical user interface comprises providing the graphical user interface by a computing system that is remote from and in communication with the server, and wherein updating the mapping is performed by a controller of the computing system.

19. The system of claim 15, wherein each repeated set of fields represents a respective row of a table within the document, wherein receiving the input directed to the at least one field comprises receiving an input indicating an extent of the table within the document, and wherein updating the mapping comprises, based on the extent of the table and the metadata, updating the mapping between the at least one repeated set of fields and at least one text block whose location within the document corresponds to the extent of the table within the document.

20. The system of claim 15, wherein generating the graphical user interface indicating the mapping comprises generating a graphical user interface indicating the mapping overlaid on an indication of the document.
